(19) United States
(12) Patent Application Publication
(10) Pub. No.: US 2004/0047631 A1
(43) Pub. Date: Mar. 11, 2004

(54) Optical communication system

(76) Inventors: Sunao Takatori, Tokyo (JP); Hisanori Kiyomatsu, Chiba (JP)

Correspondence Address: Kanesaka and Takeuchi, 1423 Powhatan Street, Suite 2, Alexandria, VA, 22314, US

(21) Appl. No.: 10/415,040

(22) PCT Filed: Oct. 29, 2001
(86) PCT No.: PCT/JP01/09463

(51) Int. Cl. H04J 14/00

(52) U.S. Cl. 398/71

(57) ABSTRACT

The object is to provide an optical communication system that can improve the line status of mobile communications while making good use of existing communication infrastructures.

The optical communication system includes a relay RS connected to an optical fiber network OPN and enabled to communicate with a plurality of mobile communication terminals MT1 toMTn. The relayRS is connected to aplurality of base stations BS1 to BSn of mobile communication terminals via the optical fiber network OPN. The relay RS connects the mobile communication terminals MT1 to MTn in a star type LAN, is capable of communicating with each of the base stations BS1 to BSn and connects the mobile communication terminal MT1 to MTn to their corresponding base stations BS1 to BSn. The relay RS, when receiving signal from on of mobile communication terminals (MT1 to MTn) in a communicable range, incorporates the mobile communication terminal into the LAN.

### TECHNICAL FIELD

The present invention relates to an optical communication system that enables communications between mobile communication terminals and base stations via optical fiber networks. More particularly, the present invention relates to a solution to solve a problem in mobile communications that the line condition is getting worse as the number of base stations increases, or higher frequencies are utilized.

### BACKGROUND ART

A plan is in progress to provide higher speed capability for fixed telephone line networks with use of an optical subscriber transmission system, while mobile communication line networks are to be provided with higher speed capability by means of next generation communication systems represented by the IMT-2000. The plan for the fixed telephone line networks and the one for the mobile communication line networks are proceeding separately. Any cooperation between them has not been under consideration. In addition, because there are a plurality of standards for the mobile communication line networks and their base stations, etc. are constructed individually, there are inevitably redundant investments from the national standpoint.

Mobile communication line networks have a problem that communications are often disabled when the number of users who attempt communications exceeds a capacity for the number of users within a servicing region of one base station. When too many base stations are provided, however, interference between radio waves is significant. In addition, because the carrier frequencies of the next generation mobile communication line networks are higher than that of the current generation, the networks may be more easily affected by obstacles, and get worse in the line status.

The present invention is made to solve current problems mentioned above, and, it is an object of the present invention to provide an optical communication system that can improve the line status in mobile communications while the infrastructures are used effectively.

### DISCLOSURE OF THE INVENTION

The optical communication system of the present invention is provided with a relay connected to an optical fiber network and enabled to communicate with mobile communication terminals, connecting the relay to base stations of mobile communication terminals via the optical fiber network. The system allows the optical fiber network to be utilized for the mobile communication, thereby achieving effective use of resources and improvement of line conditions.

In the optical communication system of the present invention, the relay functions as a dial-up router that composes a star-type local area network (LAN) with the mobile communication terminal while the relay connects the mobile communication terminals to the base station. Consequently, one relay can hold a plurality of mobile communication terminals. The LAN mentioned above may be any one that conforms to the Ethernet and Bluetooth standards.

In the optical communication system of the present invention, the relay may assign respective private addresses to respective mobile communication terminals according to a sequence to have started communications with the mobile communication terminals, and hold and manage the correspondence between phone numbers and assigned private addresses of the mobile communication terminals, while the correspondence may be erased for the mobile communication terminal that has ended its communication. Thus, a LAN can be dynamically constructed.

In the optical communication system of the present invention, the relay may receive signals from the mobile communication terminals and sends the signal to the corresponding base stations, and the base station, after holding the signal received from the mobile communication terminal, may communicate with the mobile communication terminal directly when the communication with the mobile communication terminal is enabled. Consequently, the base station can hold mobile communication terminals with the minimum increase of the load on the base station. Here, the base station, when receiving a signal from a mobile communication terminal, may send only a signal indicating reception to the mobile communication terminal directly or begin direct communication with the mobile communication terminal when the communication with the mobile communication terminal is enabled within a predetermined time. Consequently, the load on the base station can be further reduced.

In the optical communication system of the present invention, the carrier wave used for the communication between the mobile communication terminal and the relay may be different from that used for the communication between the mobile communication terminal and the base station, for example, millimeter waves may be used.

In the optical communication system of the present invention, the relay may modulate the light with use of a signal received from the mobile communication terminal and send the modulated light via the optical fiber network. Consequently, the system can be simplified.

In the optical communication system of the present invention, the mobile communication terminals and the relay may communicate with each other by means of optical space transmission.

### BRIEF DESCRIPTION OF THE DRAWINGS

FIG. 1 is a block diagram of the first embodiment of an optical communication system of the present invention;

FIG. 2 is a block diagram of the relay shown in FIG. 1;

FIG. 3 is a flowchart of the processings executed by the relay shown in FIG. 2;

FIG. 4 is a flowchart of the processings executed by a transfer device in the second embodiment of the optical communication system of the present invention;

FIG. 5 is a block diagram of the relay in the second embodiment of the optical communication system of the present invention;

FIG. 6 is a flowchart of the processings executed by the relay shown in FIG. 5;

FIG. 7 is a flowchart of the processings executed by a base station in the second embodiment;

FIG. 8 is a flowchart of other processings executed by the base station in the second embodiment;

FIG. 9 is a block diagram of a relay in the third embodiment; and

FIG. 10 is a block diagram of a relay in the fourth embodiment.

### BEST MODE FOR CARRYING OUT THE INVENTION

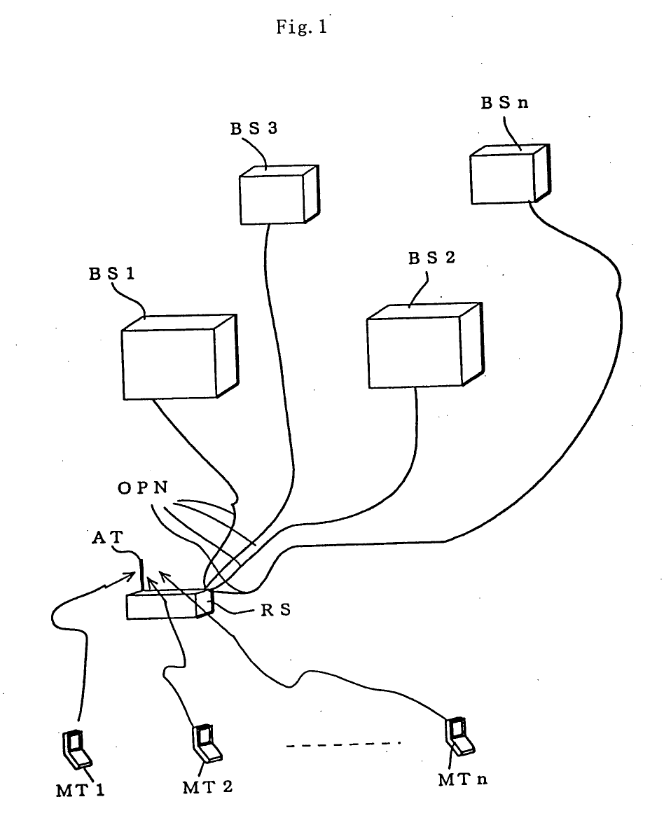

Hereunder, the present invention will be described in detail with reference to the accompanying drawings. FIG. 1 shows a block diagram of the optical communication system in the first embodiment of the present invention. This optical communication system includes a relay RS connected to an optical fiber network OPN and enabled to communicate with a plurality of mobile communication terminals MT1 to MTn. The relay RS is connected to a plurality of base stations BS1 to BSn of those mobile communication terminals via the optical fiber network OPN.

The optical fiber network OPN is a converted optical fiber network that has been used for an optical subscriber transmission system or a new optical fiber network that is created for both fixed lines and mobile communication lines. Consequently, one relay RS can hold a plurality of mobile communication terminals MT1 to MTn.

The relay RS connects the respective mobile communication terminals MT1 to MTn via a star-type local area network (LAN) and functions as a dial-up router enabled to communicate with each of the base stations BS1 to BSn so as to connect the mobile communication terminals MT1 to MTn to their corresponding base stations BS1 to BSn respectively. The relay RS, when receiving a signal from any of the mobile communication terminals MT1 to MTn in a communication enabled range (set to be adequately narrower than the communication ranges of the base stations), incorporates the mobile communication terminal (MT1 to MTn) to the LAN.

The LAN conforms to the Ethernet standards and each of the mobile communication terminals MT1 to MTn has a MAC (Media Access Control) address specific to itself. To begin communication with the relay RS, the mobile communication terminals MT1 to MTn send the MAC addresses to the relay RS. The relay RS then manages the communication with the mobile communication terminals MT1 to MTn based on this MAC address.

Base stations BS1 to BSn are intended for individual mobile communication services and each of mobile communication terminals MT1 to MTn corresponds to any one of the base stations BS1 to BSn. The relay RS sends the signal of each mobile communication terminal MT1 to MTn to the corresponding base station BS1 to BSn so as to connect the mobile communication terminal MTl to MTn to the corresponding base station BS1 to BSn via the optical fiber network OPN and the LAN.

The carrier wave used for the communication between the relay RS and respective mobile communication terminals MT1 to MTn may be different from that used for the communication between respective mobile communication terminals MT1 to MTn and respective base stations BS1 to BSn. For example, a millimeter wave may be used for the communication so as to prevent interference of the carrier waves of mobile communication services. Consequently, a mobile communication services can be provided even in areas where the line status is bad.

When the optical fiber network of an optical subscriber transmission system is used as the optical fiber network OPN, the optical fiber network of an optical subscriber transmission system can be used for the mobile communications, thereby achieving effective use of resources and improvement of line status.

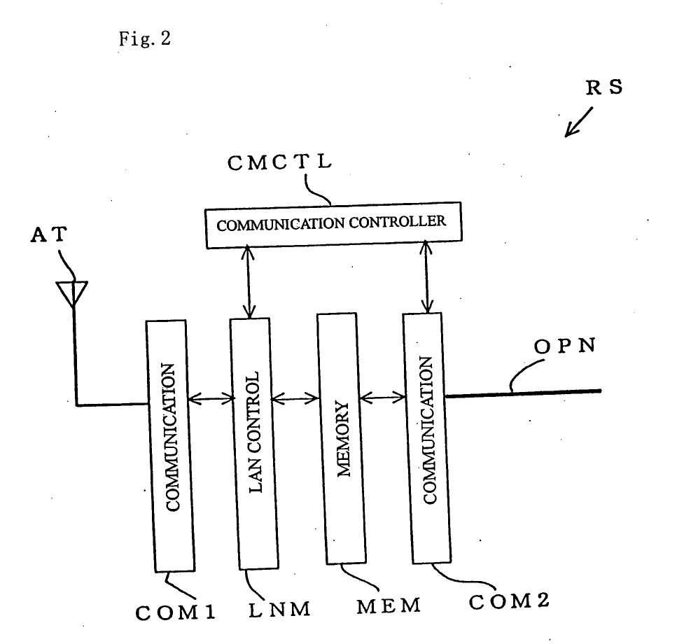

FIG. 2 shows a block diagram of a relay RS. The relay RS comprises: an antenna AT used to communicate with mobile communication terminals MT1 to MTn; a communication block COM1; a communication block COM2 used to communicate with the base stations BS1 to BSn; a LAN controller LNM used to control the LAN; a communication controller CMC used to control the relay RS entirely; and a memory MEM.

The memory MEM stores information required for controlling the LAN, information or the correspondence between the mobile communication services and base stations BS1 to BSn, and holds transmission/reception signals transmitted/received between respective mobile communication terminals MT1 to MTn and respective base stations BS1 to BSn as needed.

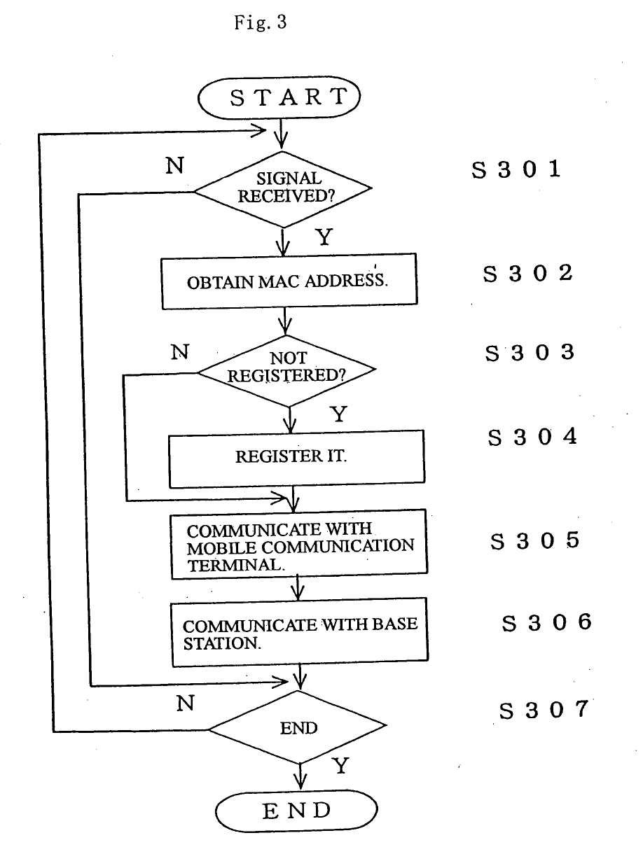

FIG. 3 shows a flowchart of the processings executed by the relay RS. At first, the relay RS decides whether or not a signal is received from a mobile communication terminal (assumed to be MTi in this case) (step S301). When the decision result is YES (received), the relay RS obtains the MAC address (step S302). Because the MAC address of each mobile communication terminal incorporated to the LAN is registered in the memory MEM, the relay decides whether or not the MAC address of the mobile communication terminal MTi is already registered in the memory MEM (step S303). When the decision result is NO (not registered), the relay RS registers the MAC address in the memory MEM (step S304), then executes communication with the mobile communication terminal MTi as needed (step S305). When the decision result is YES (registered), the relay RS begins communication with the MTi immediately.

The LAN controller LNM manages each of the mobile communication terminals MT1 to MTn based on the MAC address or the private address assigned to the respective mobile communication terminals MT1 to MTn corresponding to the MAC address. Thus, it is possible to dynamically construct a LAN.

Private addresses are assigned to mobile communication terminals in the order, for example, in which the mobile communication terminals begin communications with the relay RS. After this, the relay RS communicates with the corresponding base station (assumed to be BSj in this case)(step S306) to execute necessary communication processing. Communication is then established for the newly added mobile communication terminal MTi.

The relay RS then decides whether to end the processing (step S307). When the decision result is NO (not end), the relay RS goes back to step S301 to decide whether the next signal which is sent from the same mobile communication terminal MTi or a signal which is sent from another mobile communication terminal is received or not.

The LAN standards are not limited only to those of the Ethernet; they may be those of the Bluetooth, etc.

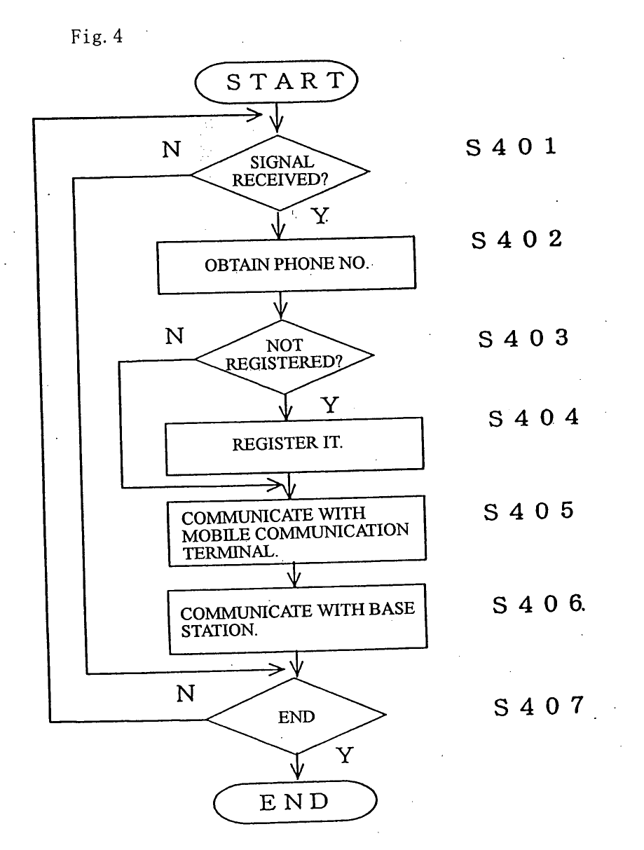

Next, the optical communication system in the second embodiment of the present invention will be described. FIG. 4 shows a flowchart of the processings executed by the relay RS in this second embodiment. In this second embodiment, MAC addresses used to manage mobile communication terminals in the first embodiment are replaced with phone numbers of the mobile communication terminals MT1 to MTn. At first, the relay RS decides whether or not a signal is received from the mobile communication terminal MTi (step S401). When the decision result is YES (received), the relay RS obtains the phone number of the mobile communication terminal MTi (step S402). Because the phone numbers of the mobile communication terminals connected to the LAN are all registered in the memory MEM, the relay RS decides whether or not the phone number of the mobile communication terminal MTi is registered (step S403). When the decision result is NO (not registered), the relay RS registers the phone number (step S404), then begins communication with the mobile communication terminal MTi as needed (step S405). When the decision result is YES (registered), the relay RS begins communication with the mobile communication terminal MTi immediately.

The relay RS then communicates with the base station BSj (step S406) to execute necessary communication processing. Thus, the communication with the newly added mobile communication terminal MTi is established. After this, the relay RS decides whether to end the processing (step S407) When the decision result is NO (not end), the relay RS goes back to step S401 to decide whether the next signal which is sent from the same mobile communication terminal MTi or a signal which is sent from another mobile communication terminal is received or not.

The LAN controller LNM manages each of the mobile communication terminals MT1 to MTn according to the phone number itself or a private address assigned to the mobile communication terminal corresponding to the phone number.

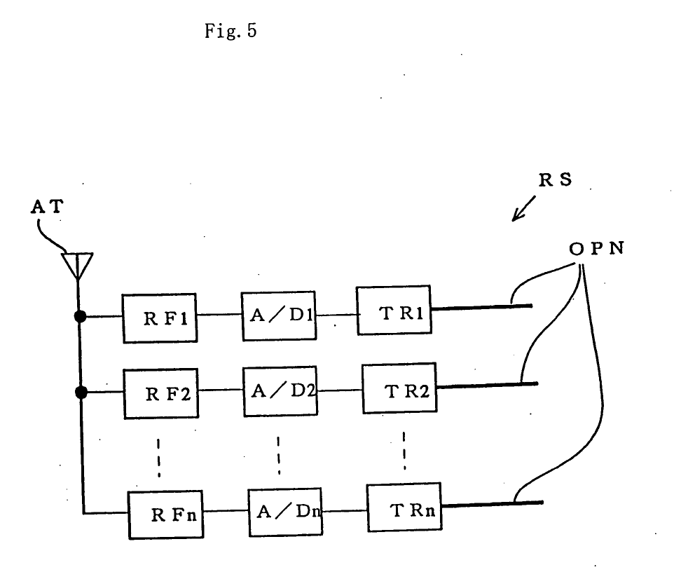

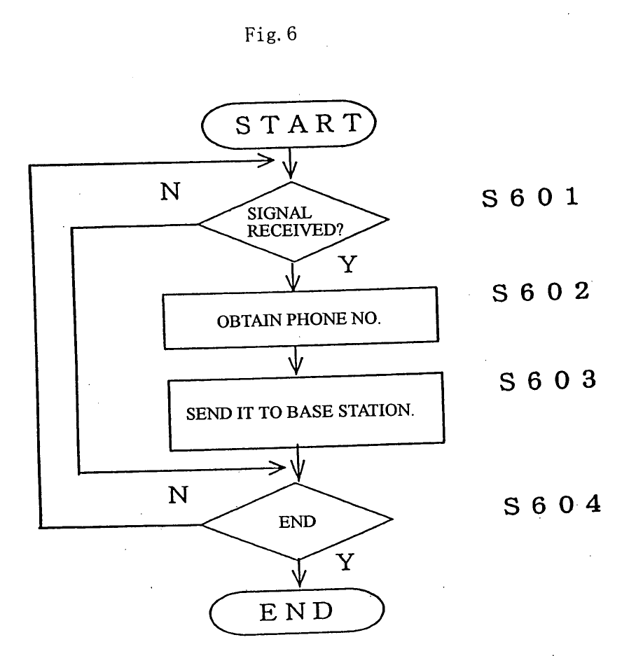

Next, the optical communication system in the third embodiment of the present invention will be described. FIG. 5 shows a block diagram of a relay RS in this third embodiment. FIG. 6 shows a flowchart of the processings executed by the relay RS. The relay RS in this third embodiment is not used to relay the communication between each mobile communication terminal and the base station. It is used just to transfer signals received from mobile communication terminals to their corresponding base stations.

In FIG. 5, the relay RS is provided with a plurality of radio frequency processors RF1 to RFn corresponding to the base stations BS1 to BSn. Analog/digital converters A/D1 to A/Dn are connected to those radio frequency processors RF1 to RFn. The analog/digital converters A/D1 to A/Dn are used to convert signals output from the radio frequency processors RF1 to RFn to digital signals to be inputted to optical signal transmitters TR1 to TRn respectively.

The optical signal transmitters TR1 to TRn are used to send optical signals corresponding to the signals output from the analog/digital converters A/D1 to A/Dn to the corresponding base stations BS1 to BSn via the optical fiber network OPN respectively. When a mobile communication terminal (MT1 to MTn) makes an attempt to send an e-mail/voice mail, the relay RS sends the attempt data to the corresponding base station and the base station sends an acknowledge signal which denotes that the data has received to the mobile communication terminal. When a mobile communication terminal requests sending/receiving of data via the corresponding base station, the relay RS sends the request to the corresponding base station and the base station holds the request once, then begins communication with the mobile communication terminal when the communication is enabled. Therefor, the relay RS can hold the mobile communication terminals MT1 to MTn while the increase of the load of each base station is minimized.

FIG. 6 shows a flowchart of the processings executed by the relay RS. At first, the relay RS decides whether or not a signal is received from the mobile communication terminal MTi (step S601). When the decision result is YES (received), the relay RS obtains the phone number of the mobile communication terminal MTi (step S602). The relay RS then selects the base station BSj corresponding to the obtained phone number and sends the received signal to the base station BSj (step S603). After this, the relay RS decides whether to end the processing (step S604). When the decision result is NO (not end), the relay RS returns to step S601 to decide whether the next signal which is sent from the same mobile communication terminal MTi or a signal which is sent from another mobile communication terminal is received or not.

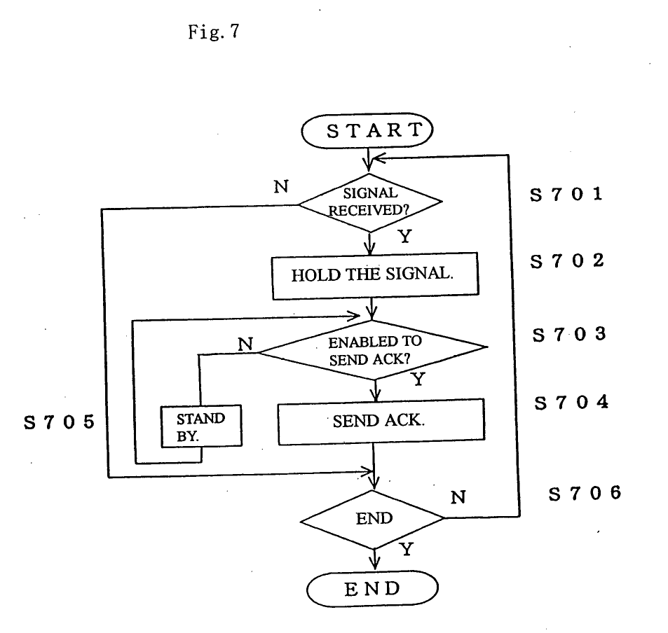

FIG. 7 shows a flowchart of the processings executed by the base station BSj in response to an e-mail/voice mail sent from a mobile communication terminal MTi. At first, the base station BSj decides whether or not a signal is received from the relay RS (step S701). When the decision result is YES (received), the base station BSj holds the signal once (step S702). Then, the base station BSj decides whether or not it is possible to send an acknowledge signal to the mobile communication terminal MTi (step S703). When the decision result is YES (possible), the base station BSj sends the acknowledge signal to the mobile communication terminal (step S704). When the decision result is NO (not possible) because the internal processing is busy, the base station BSj stands by for a predetermined time (step S705), then returns to step S703. After this, the base station BSj decides whether to end the processing in the relay RS (step S706). When the decision result is NO (not end), the base station BSj returns to step S701 to decide whether the next signal which is sent from the same mobile communication terminal MTi or a signal which is sent from another mobile communication terminal is received or not.

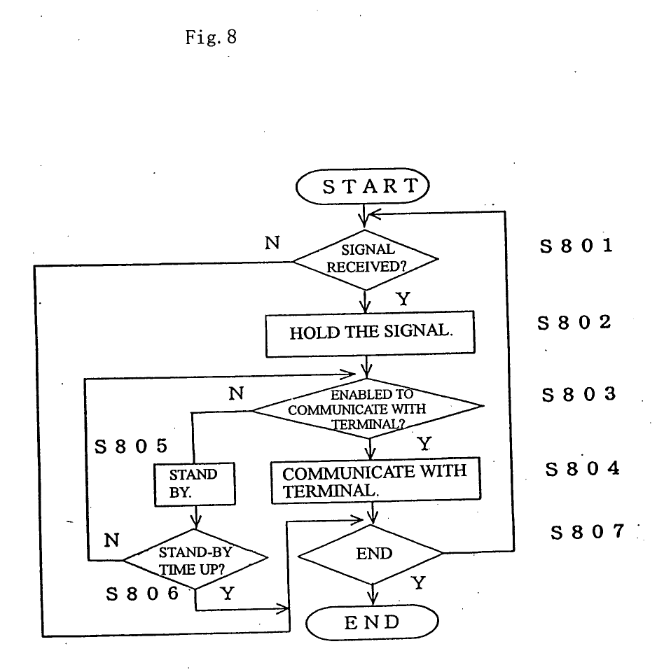

FIG. 8 shows a flowchart of the processings executed by the base station BSj in response to a request of the mobile communication terminal MTi for communication via the base station BSj.

At first, the base station BSj decides whether or not a signal is received from the relay RS (step S801). When the decision result is YES (received), the base station BSj holds the signal once (step S802). Then, the base station BSj decides whether or not it is possible to communicate with the mobile communication terminal MTi (step S803). When the decision result is YES (possible), because, for example, the communication with another mobile communication terminal is completed, the base station BSj begins the communication (step S804) . When the decision result is NO (not possible), because, for example, the internal processing is busy, the base station BSj stands by for a predetermined time (step S805), then returns to step S803.

When the processings in steps S803 and S805 are repeated, the base station BSj decides whether or not a predetermined standby time elapsed (step S806). When the decision result is NO (did not elapse), the base station BSj returns to step S803. When the decision result is YES (step S806) or when the communication in step S804 ends, the base station BSj decides whether to end the processing in the base station BSj (step S807). When the decision result is NO (not end), the base station BSj returns to step S801 to decide whether or not the next signal is received from the same mobile communication terminal MTi or a signal is received from another mobile communication terminal.

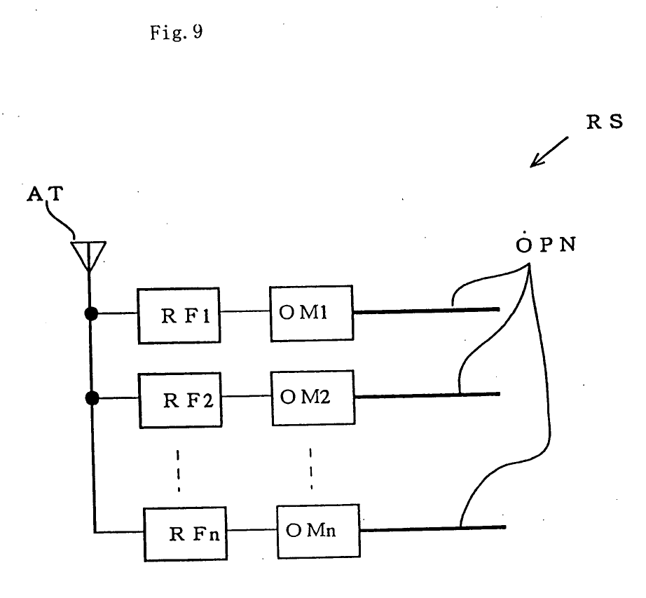

Next, the optical communication system in the fourth embodiment of the present invention will be described. FIG. 9 shows a block diagram of a relay RS in this fourth embodiment. The relay RS in the fourth embodiment converts signals received from the mobile communication terminal MTi to analog optical signals to be transferred to the base station BSj. Consequently, the system configuration can be simplified.

In FIG. 9, the relay RS is provided with a plurality of radio frequency processors RF1 to RFn corresponding to the base stations BS1 to BSn. Optical signal modulators OM1 to OMn are connected to those radio frequency processors RF1 to RFn respectively. The optical signal modulators OM1 to OMn are used to convert signals output from the radio frequency processors RF1 to RFn to analog optical signals, and these analog optical signals are sent to the corresponding base stations (BSj in this case) via the optical fiber network OPN respectively. The base station BSj detects the optical signals with use of the optical heterodyne method.

When a mobile communication terminal (MT1 to MTn) makes an attempt to send an e-mail/voice mail, the relay RS sends the attempt data to the corresponding base station and the base station sends an acknowledge signal denoting the data reception to the mobile communication terminal. When the mobile communication terminal requests communication via the base station, the relay RS sends the request to the base station and the base station holds the request once and begins the communication with the mobile communication terminal when the communication is enabled.

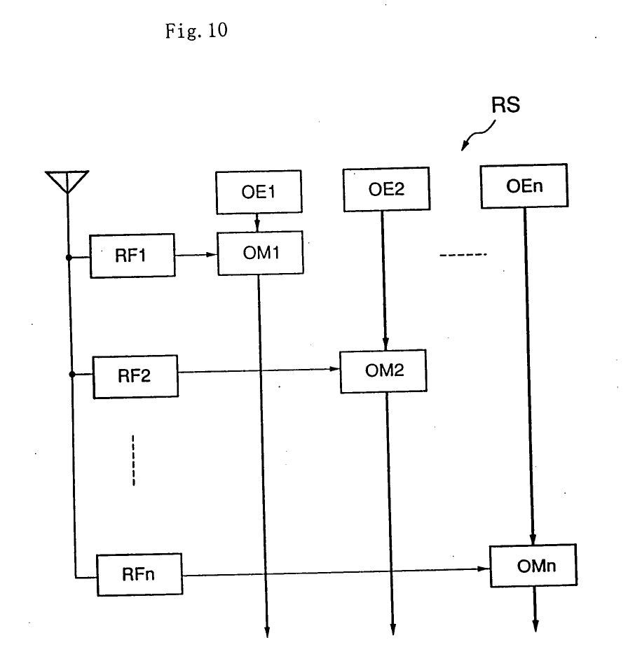

Next, an optical communication system in the fifth embodiment of the present invention will be described. FIG. 10 shows a block diagram of a relay RS in the fifth embodiment. This relay RS, just like that in the fourth embodiment, is used to convert signals received from the mobile communication terminal MTi to analog optical signals, which are transferred to the base station BSj. The relay RS modulates signals by means of an external modulation method. Consequently, the system configuration can be simplified.

In FIG. 10, the relay RS is provided with a plurality of radio frequency processors RF1 to RFn corresponding to the base stations BS1 to BSn. And, optical signal external modulators oml to omn are connected to those radio frequency processors RF1 to RFn. The optical signal external modulators oml to omn are connected to the outputs of light emitters OE1 to OEn used to output a predetermined wavelength optical signal respectively. The optical signal external modulators om1 to omn are used to modulate optical signals of the predetermined wavelength externally. Externally modulated optical signals are thus analog optical signals corresponding to respective received signals and sent to the corresponding base station BSj via the optical fiber network OPN. The base station BSj detects those optical signals with use of the optical heterodyne method.

When a mobile communication terminal (MT1 to MTn) makes an attempt to send an e-mail/voice mail, the relay RS sends the attempt data to the corresponding base station and the base station sends an acknowledge signal that denotes the data reception to the mobile communication terminal. When the mobile communication terminal requests communication via the base station, the relay RS sends the request to the base station and the base station holds the request once, then begins the communication with the mobile communication terminal when the communication is enabled.

Communication is also possible between respective mobile communication terminals MT1 to MTn and the relay RS by means of optical space transmission making use of a laser beam, of course.

### INDUSTRIAL APPLICABILITY

As described above, the optical communication system of the present invention is very useful to improve the line status of mobile communications while making good use of the communication infrastructures.

1. An optical communication system including a relay that is connected to an optical fiber network and can communicate with a mobile communication terminal, wherein the relay is connected to a base station of the mobile communication terminal via said optical fiber network.

2. The optical communication system according to claim 1;
wherein said relay is characterized in that:
said relay functions as a dial-up router that enables said mobile communication terminal to construct a star type local area network (LAN) while said mobile communication terminal is connected to said base station.

3. The optical communication system according to claim 2;
characterized in that said LAN conforms to the Ethernet standards.

4. The optical communication system according to claim 2;
characterized in that said LAN conforms to the Bluetooth standards.

5. The optical communication system according to claim 3;
characterized in that said relay assigns respective private addresses to respective mobile communication terminals according to a sequence to have started communications with said mobile communication terminals, and holds and manages the correspondence between phone numbers and said private addresses of the mobile communication terminals while erases said correspondence for the mobile communication terminal that has ended its communication.

6. The optical communication system according to claim 1;
characterized in that:
said relay receives signals from mobile communication terminals and sends said signals to the corresponding base station; and
the base station holds said signal from said mobile communication terminal and performs direct communication with the mobile communication terminal when the communication with the mobile communication terminal is enabled.

7. The optical communication system according to claim 6;
characterized in that:
said base station, when receiving a signal from said mobile communication terminal, sends only a signal that indicates reception of the signal to said mobile communication terminal directly.

8. The optical communication system according to claim 6;
characterized in that:
said base station, when receiving a signal from said mobile communication terminal, begins direct communication with the mobile communication terminal if the communication with the mobile communication terminal is enabled within a predetermined time.

9. The optical communication system according to any of claims 1 to 8;
characterized in that:
a carrier wave used for communication between said mobile communication terminal and said relay is different from that used for communication between the mobile communication terminal and the said base stations.

10. The optical communication system according to claim 9;
characterized in that the carrier is a millimeter wave.

11. The optical communication system according to claim 9;
characterized in that said relay modulates a light with a signal received from the mobile communication terminal and sends the modulated light via an optical fiber network.

12. The optical communication system according to any of claims 1 to 8;
characterized in that said mobile communication terminals and said relay communicate with each other by means of optical space transmission.
